(19) United States
(12) Patent Application Publication
(10) Pub. No.: US 2024/0345820 A1
(43) Pub. Date: Oct. 17, 2024

(54) SELF-ADAPTIVE SIMULATION SYSTEM CONFIGURED TO SUPPORT LARGE SCALE REMOTE SITE UPGRADES OF A DISTRIBUTED CONTAINER ORCHESTRATION SYSTEM

(71) Applicant: VMware, Inc., Palo Alto, CA (US)

(72) Inventors: Yan Qi, Beijing (CN); Jian Lan, Beijing (CN); Liang Cui, Beijing (CN); Qi Wang, Beijing (CN); Xiaoli Tie, Beijing (CN); Xiaojun Lin, Beijing (CN); Wenwu Peng, Beijing (CN); Shuting Ma, Beijing (CN); Weiqing Wu, San Jose, CA (US); Aravind Srinivasan, Sunnyvale, CA (US)

(21) Appl. No.: 18/133,667

(22) Filed: Apr. 12, 2023

(51) Int. Cl. G06F 8/65; G06F 9/455

(52) U.S. Cl. CPC G06F 8/65; G06F 9/45558; G06F 2009/45591

(57) ABSTRACT

The disclosure provides a method for preparing a simulation system to simulate upgrade operations for a distributed container orchestration system. The method generally includes monitoring, by a simulation operator of the simulation system, for new resources generated at a management cluster in the distributed container orchestration system, based on the monitoring, discovering, by the simulation operator, a new resource generated at the management cluster specifying a version of container orchestration software supported and made available by the management cluster, and triggering, by the simulation operator, a creation of a new mock virtual machine (VM) template in the simulation system specifying the version of the container orchestration software, wherein the simulation system is configured to use the new mock VM template for simulating mock VMs in the simulation system that are compatible with the version of the container orchestration software supported and made available by the management cluster.

Modern applications are applications designed to take advantage of the benefits of modern computing platforms and infrastructure. For example, modern applications can be deployed in a multi-cloud or hybrid cloud fashion. A multi-cloud application may be deployed across multiple clouds, which may be multiple public clouds provided by different cloud providers or the same cloud provider or a mix of public and private clouds. The term, “private cloud” refers to one or more on-premises data centers that might have pooled resources allocated in a cloud-like manner. Hybrid cloud refers specifically to a combination of public cloud and private clouds. Thus, an application deployed across a hybrid cloud environment consumes both cloud services executing in a public cloud and local services executing in a private data center (e.g., a private cloud). Within the public cloud or private data center, modern applications can be deployed onto one or more virtual machines (VMs), containers, application services, and/or the like.

A container is a package that relies on virtual isolation to deploy and run applications that depend on a shared operating system (OS) kernel. Containerized applications, can include a collection of one or more related applications packaged into one or more containers. In some orchestration systems, a set of one or more related containers sharing storage and network resources, referred to as a pod, may be deployed as a unit of computing software. Container orchestration systems automate the lifecycle of containers, including such operations as provisioning, deployment, monitoring, scaling (up and down), networking, and load balancing.

Kubernetes® (K8S®) software is an example open-source container orchestration system that automates the deployment and operation of such containerized applications. In particular, Kubernetes may be used to create a cluster of interconnected nodes, including (1) one or more worker nodes that run the containerized applications (e.g., in a worker plane) and (2) one or more control plane nodes (e.g., in a control plane) having control plane components running thereon that control the cluster. Control plane components make global decisions about the cluster (e.g., scheduling), and can detect and respond to cluster events (e.g., starting up a new pod when a workload deployment's intended replication is unsatisfied). As used herein, a node may be a physical machine, or a VM configured to run on a physical machine running a hypervisor.

In some cases, the container orchestration system, running containerized applications, is distributed across a cellular network. A cellular network provides wireless connectivity to moving devices and generally comprises two primary subsystems: a mobile core connected to the Internet and a radio access network (RAN) composed of cell sites. In a RAN deployment, such as a fifth-generation network technology (5G) RAN deployment, cell site network functions may be realized as pods in container-based infrastructure. In particular, each cell site is deployed with an antenna and one or more hosts. The cell site hosts may be used to execute various network functions using containers (referred to herein as “cloud-native network functions (CNFs)). The CNFs may be deployed as pods of containers running within VMs of the cell site hosts or directly on an operating system (OS) of the cell site hosts.

5G is expected to deliver a latency of under 5 milliseconds and provide transmission speeds up to about 20 gigabytes per second. With these advancements, 5G is expected to support higher speed and more reliable mobile communications and video streaming services, immersive user interfaces, mission-critical applications (e.g., public safety, autonomous vehicles), smart home appliances, industrial robots, and the Internet-of-Things (IoT). To meet the 5G requirements, with respect to high network throughput and low latency, cell site hosts and VMs are configured to include specialized hardware, software, and customizations. For example, hosts at a 5G cell site may include 5G specific accelerator network cards, precision time protocol (PTP) devices, basic input/output system (BIOS) tuning, firmware updates, and/or driver installation to support 5G network adapters. Examples of 5G specific accelerator network cards include the Intel® vRAN dedicated accelerator ACC100. PTP devices include the Intel® E810 network adapter XXV710.

In some cases, a telecommunication cloud platform (TCP) enables configuring cell site hosts and VMs of the 5G cellular network as such. In particular, the TCP uses a centralized management server to manage and customize numerous cell site hosts and VMs (e.g., a 5G RAN deployment may include more than 10,000 remote cell sites managed by the TCP) of the cellular network to support 5G RAN telecommunication requirements. To verify functionalities and performance of customized cell site hosts and VMs in the large scale RAN deployment, the TCP may include a simulation system. The simulation system provides a test infrastructure for end-to-end scale verification of node creation and customization of mock hosts and mock VMs of RAN cell sites, as well as a mock centralized management server configured to manage such mock hosts and VMs.

In some cases, an ability of the simulation system to simulate upgrade operations to customized cell site components in the large scale RAN deployment may also be desired. For example, existing VMs in the RAN deployment may be upgraded to take advantage of new features, enhancements, and/or critical security updates provided by newly-released container orchestration platform versions, such as Kubernetes versions. To perform this upgrade, a new base image template (e.g., also referred to herein as a “VM template”) is created specifying a newly-released container orchestration platform version for which the template is compatible. The new base image template may be uploaded to a virtualization management platform deployed to carry out administrative tasks for at least one workload cluster. Uploading the new base image template enables upgrades of VMs of the workload cluster at different cell sites managed by the platform based on the new base image template. As such, an ability of the simulation system to simulate similar upgrade operations may be useful to verify upgrade functionalities and provide insight into performance of the upgrade at cell sites in the large scale RAN deployment.

### SUMMARY

One or more embodiments provide a method for preparing a simulation system to simulate upgrade operations in a distributed container orchestration system. The method generally includes monitoring, by a simulation operator of the simulation system, for new resources generated at a management cluster in the distributed container orchestration system. Based on the monitoring, the method generally includes discovering, by the simulation operator, a new resource generated at the management cluster specifying a version of container orchestration software supported and made available by the management cluster. Further, the method generally includes triggering, by the simulation operator, a creation of a new mock virtual machine (VM) template in the simulation system specifying the version of the container orchestration software. The simulation system is configured to use the new mock VM template for simulating mock VMs in the simulation system that are compatible with the version of the container orchestration software supported and made available by the management cluster.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 illustrates an example cellular network, having at least a software-defined data center (SDDC) including a simulation system, a mobile core, and multiple cell sites, in which embodiments of the present disclosure may be implemented.

FIGS. 2A and 2B illustrate an example container execution environment run on cell site hosts, according to an example embodiment of the present disclosure.

FIG. 3 illustrates example components of the SDDC, including the simulation system, illustrated in the cellular network of FIG. 1, according to an example embodiment of the present disclosure.

FIG. 4 is an example workflow for configuring mock hosts of cell sites and a local data center (LDC) of a cellular network, according to an example embodiment of the present disclosure.

FIGS. 5A and 5B provide an exploded view of a simulation system for creating mock hosts of RAN cell sites and a mobile core of an LDC, according to an example embodiment of the present disclosure.

FIG. 6 illustrates a self-adaptive cell site simulation system, according to an example embodiment of the present disclosure.

FIG. 7 is an example workflow for automatically deploying new mock VM templates in a cell site simulation system, according to an example embodiment of the present disclosure.

FIG. 8 illustrates an example telecommunication cloud automation (TCA) Bill of Materials (BOM) Release (TBR), according to an example embodiment of the present disclosure.

FIG. 9 illustrates an example properties of a mock VM template generated by a simulator in the simulation system introduced in FIG. 3, according to an example embodiment of the present disclosure

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Techniques for simulating large scale remote site upgrades in a distributed container orchestration system are described herein. The distributed container orchestration system may be a container orchestration system distributed across a cellular network having a mobile core and a RAN composed of multiple remote cell sites. The upgrade simulation may be performed to verify an ability of the system to upgrade virtual machines (VMs) deployed at the multiple cell sites such that the VMs are compatible with a latest container orchestration platform version release, such as a latest Kubernetes version release. Upgrading VMs to be compatible with a latest Kubernetes version release enables the VMs to leverage new features, enhancements, and/or critical security updates provided by the updated software. Though certain aspects are discussed with respect to Kubernetes, the techniques and aspects herein are also applicable to other container orchestration platforms.

The simulation system described herein is configured to use a mock base image template, or mock VM template, for generating mock VMs in test infrastructure to represent RAN cell site VMs. The mock base image template mocks a base image template that may have initially served as a baseline image for creating and deploying VMs at RAN cell sites in the cellular network (e.g., a first base image template initially deployed for the container orchestration system). The initially-deployed base image template, and accordingly the mock base image template, includes one or more properties configured for the template, and further specifies, at least, a Kubernetes version for which the base image template is compatible. As such, mock VMs created and deployed in the test infrastructure, using the mock base image template, may be VMs compatible with a latest Kubernetes version that was available when the base image template was initially deployed. However, Kubernetes is constantly evolving, and compatibility of existing VMs in the cellular network may need to be consistent with the latest software version to take advantage of new features provided by the updated software.

To support simulated upgrades to the mock VMs, the simulation system is configured to generate a new mock base image template (e.g., for generating mock VMs) each time the management cluster of the container orchestration system is upgraded to support a new Kubernetes version release. For example, a simulation operator, having an upgrade controller, is deployed in the simulation system. The upgrade controller is configured to monitor for upgrades to the management cluster. Upgrades to the management cluster result in the generation of new resources on the management cluster, specifying new versions of Kubernetes supported and made available by the management cluster. As such, the upgrade controller may monitor for these new resources, and when a new resource is discovered, trigger the creation of a new mock base image template in the simulation system. The new mock base image template specifies the new Kubernetes version supported by the management cluster. A simulator of the simulation system then generates new mock VMs with properties that match the requirements of the new mock base image template, including at least a compatibility with the new Kubernetes version. As such, embodiments herein provide a self-adaptive simulation system configured to support remote cell site VM upgrades in the cellular network. Though certain aspects are discussed with respect to the generation, in a simulation system, of new templates specifying newly-released container orchestration platform versions for which the template is compatible, the techniques and aspects herein are also applicable to the generation of new templates in the simulation system that specify newly-released operating system (OS) versions.

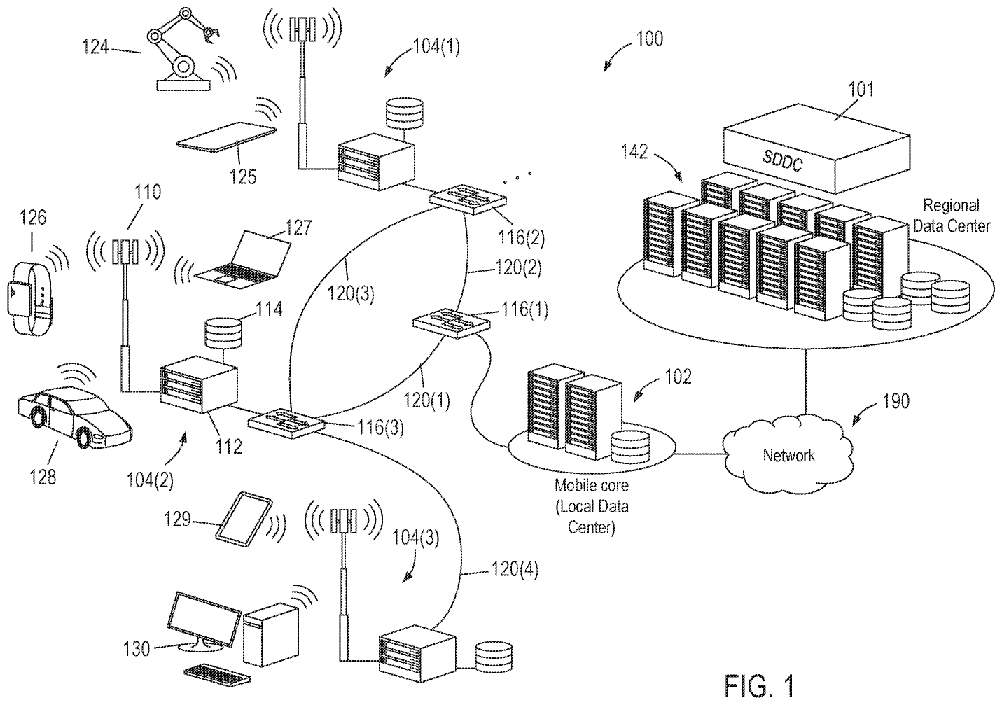

FIG. 1 illustrates an example cellular network 100 in which embodiments of the present disclosure may be implemented. Cellular network 100 provides wireless 5G connectivity to user equipment(s) (UE(s)). UEs include mobile phones, computers, automobiles, drones, industrial and agricultural machines, robots, home appliances, and Internet-of-Things (IoT) devices. Example UEs illustrated in FIG. 1 include a robot 124, a tablet 125, a watch 126, a laptop 127, an automobile 128, a mobile phone 129, and a computer 130. To provide such 5G connectivity, cellular network 100 includes a mobile core 102, a RAN composed of cell sites, such as example cell sites 104(1)-104(3) (individually referred to herein as “cell site 104” and collectively referred to herein as “cell sites 104”), and a telecommunication cloud platform (TCP) deployed in a software-defined data center (SDDC) 101 at a regional data center (RDC) 142.

Mobile core 102 is the center of cellular network 100. Cellular network 100 includes a backhaul network that comprises intermediate links, such as cables, optical fibers, and switches, and connects mobile core 102 to cell sites 104. In the example of FIG. 1, the backhaul network includes switches 116(1)-116(3) and intermediate links 120(1)-120(4). In certain embodiments, the intermediate links 120 are optical fibers. In certain embodiments, the backhaul network is implemented with wireless communications between mobile core 102 and cells sites 104.

Mobile core 102 is implemented in a local data center (LDC) that provides a bundle of services. For example, mobile core 102 provides (1) internet connectivity data and voice services, (2) ensures the connectivity satisfies quality-of-service (QoS) requirements of communication service providers (CSPs), (3) tracks UE mobility to ensure uninterrupted service as users travel, and (4) tracks subscriber usage for billing and charging. Mobile core 102 provides a bridge between the RAN in a geographic area and a larger IP-based Internet.

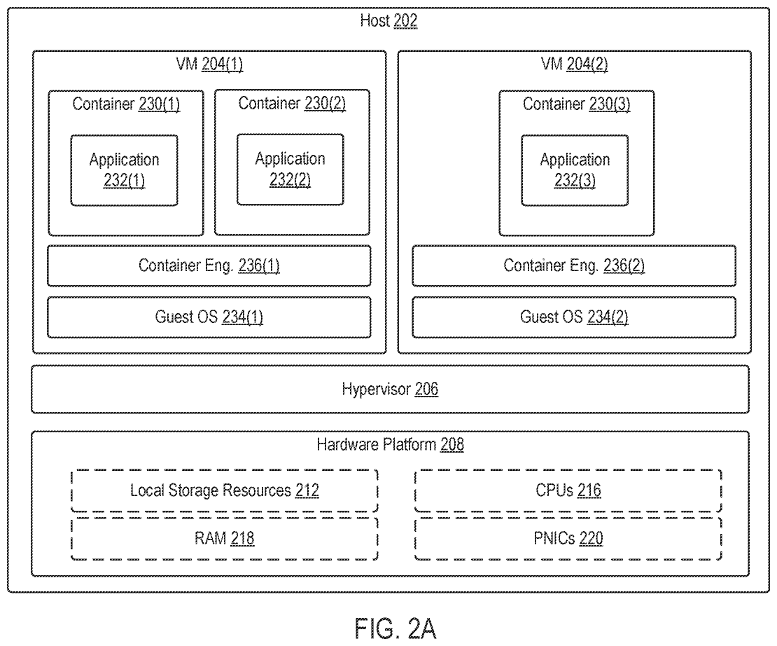

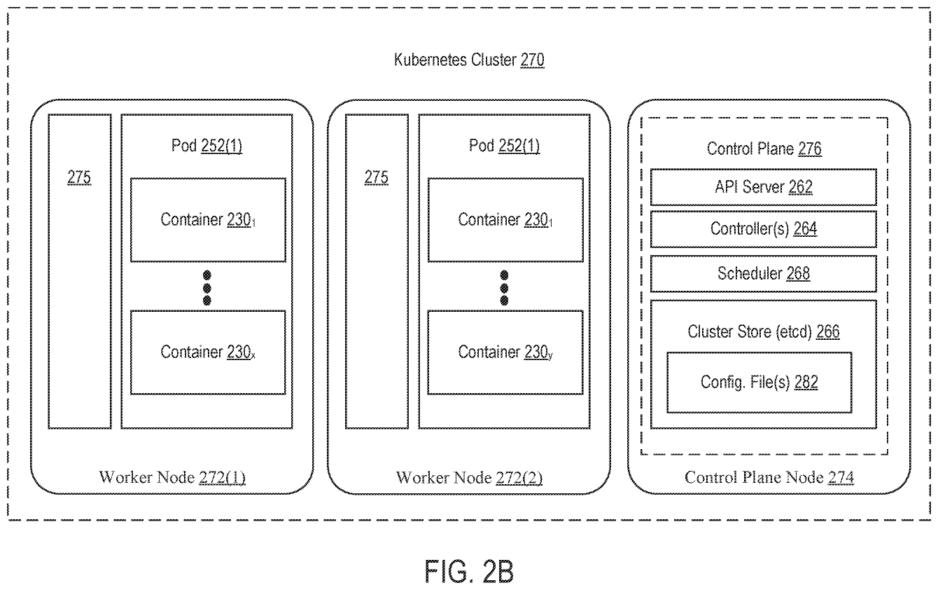

The RAN can span dozens, or even hundreds, of cell sites 104. Each cell site 104 includes an antenna 110 (e.g., located on a tower), one or more computer systems 112, and a data storage appliance 114. Cells sites 104 are located at the edge of cellular network 100. Computer systems 112 at each cell site 104 run management services that maintain the radio spectrum used by the UEs and make sure the cell site 104 is used efficiently and meets QoS requirements of the UEs that communicate with the cell site. Computer systems 112 are examples of host computer systems or simply “hosts.” A host is a geographically co-located server that communicates with other hosts in cellular network 100. Network functionalities performed at cell sites 104 are implemented in distributed applications with application components that are run in virtual machines (VMs) or in containers that run on cell site 104 hosts. Additional details regarding an example container execution environment run on cell site 104 hosts is provided in FIGS. 2A and 2B.

SDDC 101 is in communication with cell sites 104 and mobile core 102 through a network 190. Network 190 may be a layer 3 (L3) physical network. Network 190 may be a public network, a wide area network (WAN) such as the Internet, a direct link, a local area network (LAN), another type of network, or a combination of these.

SDDC 101 runs a telecommunications cloud platform (TCP) (not illustrated in FIG. 1) for managing the virtual environments of cell sites 104, and the LDC used to execute mobile core 102. The TCP uses a centralized management server to manage and customize components of cell sites 104 (e.g., hosts, VMs, etc.) to meet cell site 5G requirements, and more specifically, high network throughout and low latency requirements. The centralized management server may be a virtualization management platform deployed to carry out administrative tasks for hosts and/or VMs of the cell sites. In certain embodiments, the TCP includes a simulation system that verifies functionality and performance of the TCP with respect to configuring cell site components (e.g., cell site hosts and VMs) and a mobile core 102 of cellular network 100. For example, the simulation system is designed to simulate one or more of a mock virtualization management platform, mock cell site hosts, mock cell site VMs, mock cell site guest operating systems (OSs), a mock intelligent platform management interface (IPMI), and/or a mock secure shell (SSH) server to handle application programming interface (API) requests from an infrastructure automation engine (IAE) operator and a host configuration (HostConfig) operator, where the IAE and hostconfig operators are designed to configure (e.g., customize) mock cell site hosts and VMs. Additional details regarding such simulation is described in detail below.

FIGS. 2A and 2B illustrate an example container execution environment run on cell site 104 hosts, according to an example embodiment of the present disclosure. In particular, FIG. 2A illustrates a cell site host 202 (e.g., an example of a computer system 112 illustrated in FIG. 1) configured to run containerized applications.

Host 202 may be constructed on a server grade hardware platform 208, such as an x86 architecture platform. Hardware platform 208 of each host 202 includes components of a computing device such as one or more processors (central processing units (CPUs)) 216, memory (random access memory (RAM)) 218, one or more network interfaces (e.g., physical network interfaces (PNICs) 220), local storage 212, and other components (not shown). CPU 216 is configured to execute instructions that may be stored in memory 218, and optionally in storage 212. The network interface(s) enable host 202 to communicate with other devices via a physical network, such as management network and/or a data network. In certain embodiments, host 202 is configured to access an external storage (e.g., a storage area network (SAN), a virtual SAN, network attached storage (NAS), or the like) using PNICs 220. In another embodiment, host 202 contains a host bus adapter (HBA) through which input/output operations (I/Os) are sent to an external storage over a separate network (e.g., a fibre channel (FC) network).

Host 202 may be configured to provide a virtualization layer, also referred to as a hypervisor 206, which abstracts processor, memory, storage, and networking resources of hardware platform 208 of host 202 into one or multiple VMs 204 that run concurrently on host 202, such as VM 204(1) and VM 204(2) running on host 202 in FIG. 2A. In certain embodiments, hypervisor 206 runs in conjunction with an OS (not shown) in host 202. In certain embodiments, hypervisor 206 is installed as system level software directly on hardware platform 208 of host 202 (often referred to as “bare metal” installation) and is conceptually interposed between the physical hardware and the guest OSs 234 executing in the VMs 204. It is noted that the term “operating system” or “OS,” as used herein, may refer to a hypervisor. One example of hypervisor 206 that may be configured and used in embodiments described herein is a VMware ESXi™ hypervisor provided as part of the VMware vSphere® solution made commercially available by VMware, Inc. of Palo Alto, CA.

Further, each of VMs 204 implements a virtual hardware platform that supports the installation of a guest OS 234 which is capable of executing one or more applications 232. Guest OS 234 may be a standard, commodity operating system. Examples of a guest OS 234 include Microsoft Windows, Linux, and/or the like. Applications 232 may be any software program, such as a word processing program.

In certain embodiments, each VM 204 includes a container engine 236 installed therein and running as a guest application under control of guest OS 234. Container engine 236 is a process that enables the deployment and management of virtual instances, referred to herein as “containers 230,” in conjunction with OS-level virtualization on guest OS 234 within VM 204. Containers 230 provide isolation for user-space processes executing within them. Containers 230 encapsulate an application 232 as a single executable package of software that bundles application code together with all of the related configuration files, libraries, and dependencies required for it to run. In certain embodiments, containers 230 are used to execute various network functions in cellular network 100, illustrated in FIG. 1.

Kubernetes provides a platform for automating deployment, scaling, and operations of such containers 230 across cell site hosts 202. In particular, Kubernetes implements an orchestration control plane, such as a Kubernetes control plane, to deploy containers 230 running on cell site hosts 202. Kubernetes may be used to create a cluster of interconnected nodes, including (1) worker nodes that run containerized applications and/or services (e.g., in a worker plane) and (2) one or more control plane nodes (e.g., in a control plane) that control the cluster.

An example container-based cluster for running containerized applications and CNFs is illustrated in FIG. 2B. While the example container-based cluster shown in FIG. 2B is a Kubernetes cluster 270, in other examples, the container-based cluster may be another type of container-based cluster based on container technology, such as Docker Swarm clusters. As illustrated in FIG. 2B, Kubernetes cluster 270 comprises worker nodes 272 that run one or more pods 252 having containers 230. Further, Kubernetes cluster 270 comprises control plane node(s) 274 having control plane components running thereon that control the cluster (e.g., where a node is a physical machine, such as a hosts 202, or a VM 204 configured to run on a host 202).

Each worker node 272 includes a kubelet 275. Kubelet 275 is an agent that helps to ensure that one or more pods 252 run on each worker node 272 according to a defined state for the pods 252, such as defined in a configuration file. Each pod 252 may include one or more containers 230. The worker nodes 272 can be used to execute various applications and software processes (e.g., CNFs) using containers 230. Further, each worker node 272 may include a kube proxy (not illustrated in FIG. 2B). A kube proxy is a network proxy used to maintain network rules. These network rules allow for network communication with pods 252 from network sessions inside and/or outside of Kubernetes cluster 270.

Control plane 276 (e.g., running on one or more control plane nodes 274) includes components such as an application programming interface (API) server 262, controller(s) 264, a cluster store (etcd) 266, and scheduler(s) 168. Control plane 276's components make global decisions about Kubernetes cluster 270 (e.g., scheduling), as well as detect and respond to cluster events.

API server 262 operates as a gateway to Kubernetes cluster 270. As such, a command line interface, web user interface, users, and/or services communicate with Kubernetes cluster 270 through API server 262. One example of a Kubernetes API server 262 is kube-apiserver. The kube-apiserver is designed to scale horizontally—that is, this component scales by deploying more instances. Several instances of kube-apiserver may be run, and traffic may be balanced between those instances.

Controller(s) 264 is responsible for running and managing controller processes in Kubernetes cluster 270. As described above, control plane 276 may have (e.g., four) control loops called controller processes, which watch the state of Kubernetes cluster 270 and try to modify the current state of Kubernetes cluster 270 to match an intended state of Kubernetes cluster 270. Scheduler(s) 268 is configured to allocate new pods 252 to worker nodes 272.

Cluster store (etcd) 266 is a data store, such as a consistent and highly-available key value store, used as a backing store for Kubernetes cluster 270 data. In certain embodiments, cluster store (etcd) 266 stores configuration file(s) 282, such as JavaScript Object Notation (JSON) or YAML files, made up of one or more manifests that declare intended system infrastructure and workloads to be deployed in Kubernetes cluster 270.

A Kubernetes object is a “record of intent”—once an object is created, the Kubernetes system will constantly work to ensure that object is realized in the deployment. One type of Kubernetes object is a custom resource definition (CRD) object (also referred to herein as a “custom resource (CR)”) that extends an API or allows a user to introduce their own API into Kubernetes cluster 270. In particular, Kubernetes provides a standard extension mechanism, referred to as custom resource definitions, that enables extension of the set of resources and objects that can be managed in a Kubernetes cluster.

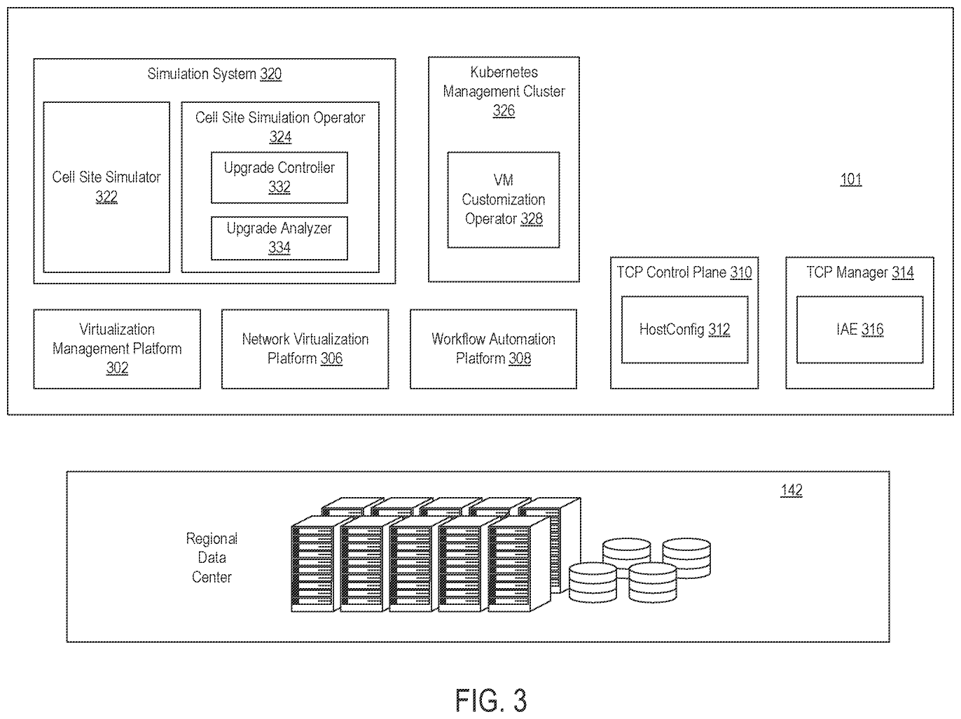

FIG. 3 illustrates example components of the SDDC 101 illustrated in the cellular network of FIG. 1, according to an example embodiment of the present disclosure. As illustrated, SDDC 101 runs on RDC 142 and includes a virtualization management platform 302, a network virtualization platform 306, a workflow automation platform 308, a TCP (e.g., illustrated as TCP control plane 310 and a TCP manager 314), and a Kubernetes management cluster 326. Further, as described above, SDDC 101 includes a simulation system 320 configured to verify functionality and performance of the TCP with respect to configuring cell site 104 hosts 202 and/or VMs 204 and a mobile core 102 of cellular network 100.

Virtualization management platform 302 manages virtual and physical components, such as VMs, hosts, and dependent components, from a centralized location in SDDC 101. Virtualization management platform 302 is a computer program that executes in a host in SDDC 101, or alternatively, virtualization management platform 302 runs in a VM deployed on a host in SDDC 101. One example of a virtualization management platform 302 is the vCenter Server® product made commercially available by VMware, Inc. of Palo Alto, California.

Network virtualization manager 306 is a physical or virtual server that orchestrates a software-defined network layer. A software-defined network layer includes logical network services executing on virtualized infrastructure (e.g., of hosts). The virtualized infrastructure that supports logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure.

In certain embodiments, network virtualization manager 306 includes one or more virtual servers deployed as VMs in SDDC 101. One example of a software-defined networking platform that can be configured and used in embodiments described herein as network virtualization manager 306 and the software-defined network layer is a VMware NSX® platform made commercially available by VMware, Inc. of Palo Alto, California.

The SDDC 101 runs a workflow automation platform 308 which is an automated management tool that integrates workflows for VMs and containers. An example workflow automation platform 308 may be vRealize Orchestrator (VRO) provided by VMware, Inc. of Palo Alto, California.

TCP control plane 310 connects the virtual infrastructure of cell sites 104 and mobile core 102 (e.g., illustrated in FIG. 1) with RDC 142. TCP control plane 310 supports several types of virtual infrastructure managers (VIMs), such as virtualization management platform 302. The TCP connects with TCP control plane 310 to communicate with the Vims. In certain embodiments, TCP control plane 310 includes a TCP HostConfig 312 that configures BIOS and firmware through an intelligent platform management interface (IPMI) API, and installs drivers with hypervisor commands through an SSH connection. An SSH connection is a network communication protocol that enables cell sites 104 and mobile core 102 to communicate and share data. HostConfig 312 may also update firmware through a hypervisor OS command.

TCP Manager 314 is configured to execute an IAE 316 that automatically connects with TCP control plane 310 through site pairing to communicate with VIM(s). Further, TCP manager 314 posts workflows to TCP control plane 310.

SDDC 101 enables management of large-scale cell sites 104 at a central location, such as from a console of a system administrator located at RDC 142. Hosts of cell sites 104 (e.g., such as host 202 in FIG. 2) are added and managed by virtualization management platform 302 and IAE 316 through an API of virtualization management platform 302. In certain embodiments, to tune and optimize large-scale cell site 104 hosts to meet 5G RAN cell site 104 requirements, HostConfig 312 customizes cell site 104 hosts based on 5G requirements. For example, HostConfig 312 manages host BIOS customizations, firmware upgrades, PTP device configurations, accelerator card configurations, and/or the like. After cell site 104 hosts have been configured, via HostConfig 312, a RAN cluster may be deployed having container orchestration platform worker nodes (e.g., Kubernetes worker nodes 272 in FIG. 2B) and container orchestration platform control plane nodes (e.g., Kubernetes control plane nodes 274 in FIG. 2B). The container orchestration platform worker nodes and control plane nodes may be deployed as VMs at different cell sites 104 in a cellular network (e.g., cellular network 100 in FIG. 1).

Kubernetes management cluster 326, in FIG. 3, may be deployed in SDDC 101 subsequent to deploying the RAN cluster at cell sites 104. Kubernetes management cluster 326 is a Kubernetes cluster that runs cluster API operations on a specific cloud provider to create and manage workload clusters on that provider. Kubernetes management cluster 326 may also include worker nodes and control plane nodes, similar to the RAN cluster deployed at cell sites 104.

In certain embodiments, Kubernetes management cluster 326 includes a VM customization operator 328. In certain embodiments, to tune and optimize large-scale cell site 104 VMs to meet 5G RAN cell site 104 requirements, VM customization operator 328 customizes cell site 104 VMs based on 5G requirements.

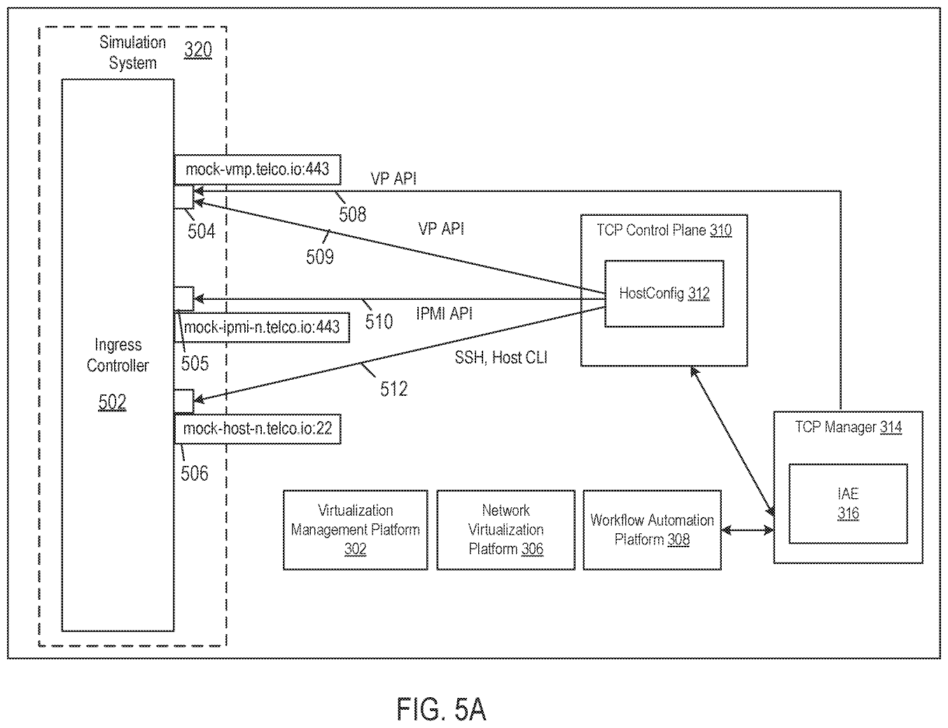

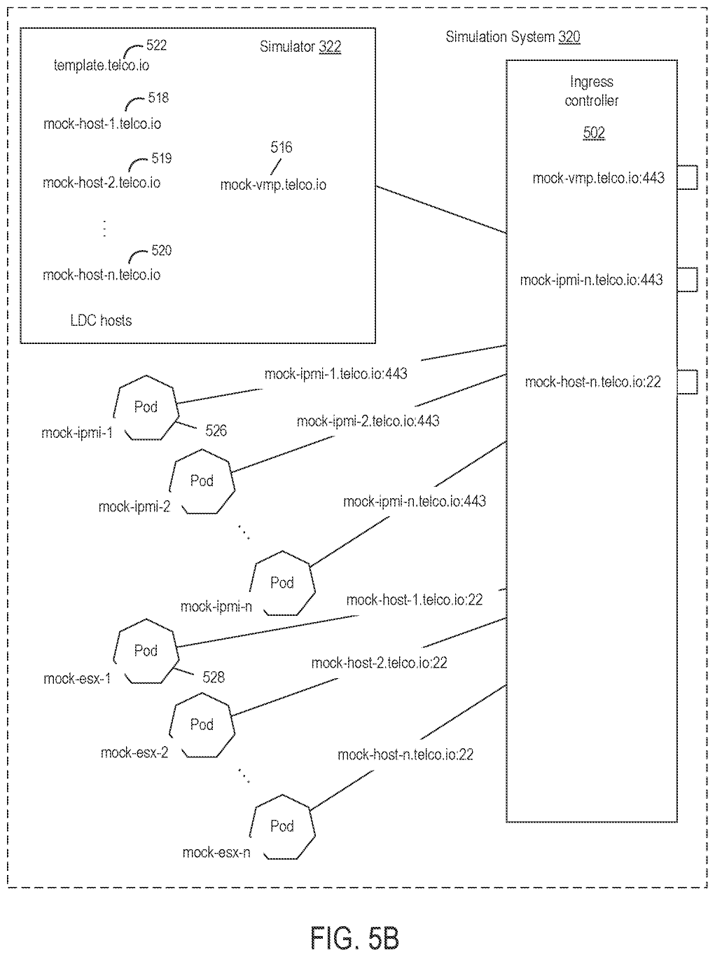

Simulation system 320 is a cloud native simulation system that provides a test infrastructure for end-to-end scale verification for IAE 316 and HostConfig 312. Simulation system 320 provides end-to-end scale tests without any changes to IAE 316 and HostConfig 312 of the TCP. Simulation system 320 simulates the configuration/customization and deployment of mock hosts in a 5G RAN deployment using IAE 316 and HostConfig 312. Further, simulation system 320 simulates the configuration/customization and deployment of mock VMs in the 5G RAN deployment using VM customization operator 328. Simulation system 320 includes a cell site simulator 322 (simply referred to herein as “simulator 322”) that simulates a mock virtualization management platform managing multiple mock hosts, as well as mock VMs running on those mock hosts. In particular, in certain embodiments, simulator 322 simulates a model with a mock datacenter, mock hosts, mock VMs, mock clusters, mock resource pools, and mock networks. Simulator 322 is deployed in a pod of simulation system 320. Simulation system 320 comprehensively simulates RAN cell site hosts as mock hosts using cell site simulator 322 and ingress controller 502 (shown in FIGS. 5A and 5B), as described in detail below with respect to FIGS. 5A and 5B.

Simulation system 320 may simulate RAN cell site VMs as mock VMs using a mock base image template, also referred to as a mock VM template. For example, simulator 322 may use a set of instructions for creating a mock VM (the instructions included in the mock VM template) to create the mock VM in simulation system 320. In certain embodiments, the set of instructions included in the mock VM template include instructions to create a mock VM compatible with a particular Kubernetes version identified in the VM template.

A Kubernetes version specified in the mock VM template may not always be a Kubernetes version supported by Kubernetes management cluster 326. For example, new Kubernetes versions are often released to unveil new and/or upgraded features for the container orchestration platform. As such, Kubernetes management cluster 326 is constantly updated to take advantage of these new features. Updating Kubernetes management cluster 326 does not result in an update to the mock VM template used in simulation system 320; thus, the Kubernetes version referenced in the mock VM template may not reference a latest Kubernetes version supported by Kubernetes management cluster 326. Accordingly, mock VMs created using this mock VM template may not be compatible with this latest Kubernetes version and thus, not be able to leverage features provided via the updated software.

Accordingly, in certain embodiments, simulation system 320 further includes a cell site simulation operator 324 (simply referred to herein as “simulation operator 324”) having an upgrade controller 332 and an upgrade analyzer 334. Upgrade controller 332 is configured to monitor for upgrades to Kubernetes management cluster 326. Upgrades to Kubernetes management cluster 326 result in the generation of new resources on Kubernetes management cluster 326, specifying new versions of Kubernetes supported and made available by Kubernetes management cluster 326. As such, upgrade controller 332 may monitor for these new resources, and when a new resource is discovered, trigger the creation of a new VM template in the simulation system, where the new mock VM template specifies the new Kubernetes version supported by Kubernetes management cluster 326. In particular, simulation operator 324 may trigger simulator 322 to create the new VM template specifying the new Kubernetes version. As described above, simulator 322 is configured to simulate mock VMs in simulation system 320 based on a VM template available to simulator 322; thus, new VMs simulated, based on the newly created VM template, may be compatible with a latest Kubernetes versions supported by Kubernetes management cluster 326.

In certain embodiments, simulation operator 324 further includes an upgrade analyzer 334. Upgrade analyzer 334 is configured to monitor for operations performed during an upgrade on a mock host in simulation system 320. Further, in some cases, upgrade analyzer 334 is an analyzer tool configured to analyze an upgrade strategy (e.g., a process for updating the test infrastructure using the new VM template provided via a user) based on the operations performed during the upgrade, generate an upgrade strategy analysis report, and provide such report to the user.

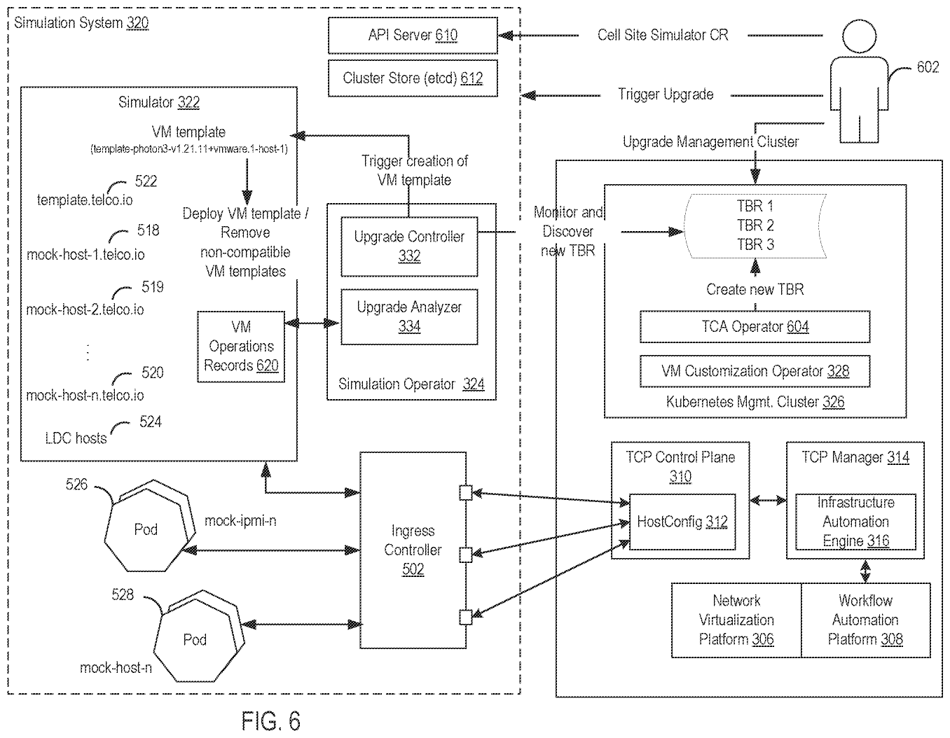

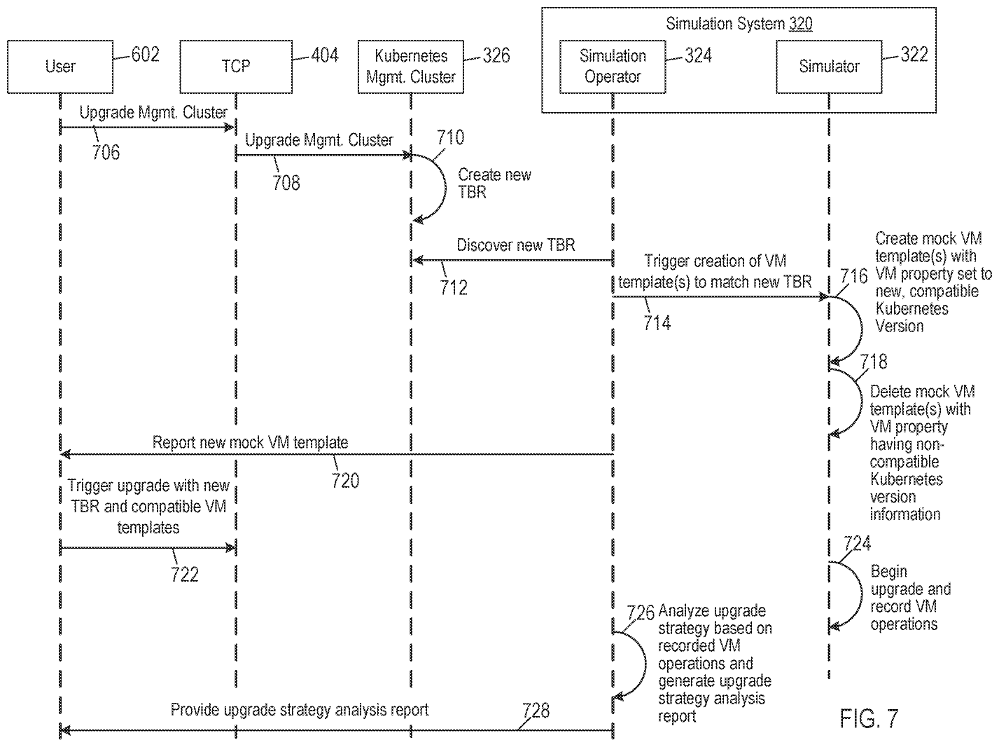

Additional details regarding generating a new VM template and triggering a simulation system upgrade using the new VM template are provided below with respect to FIGS. 6 and 7.

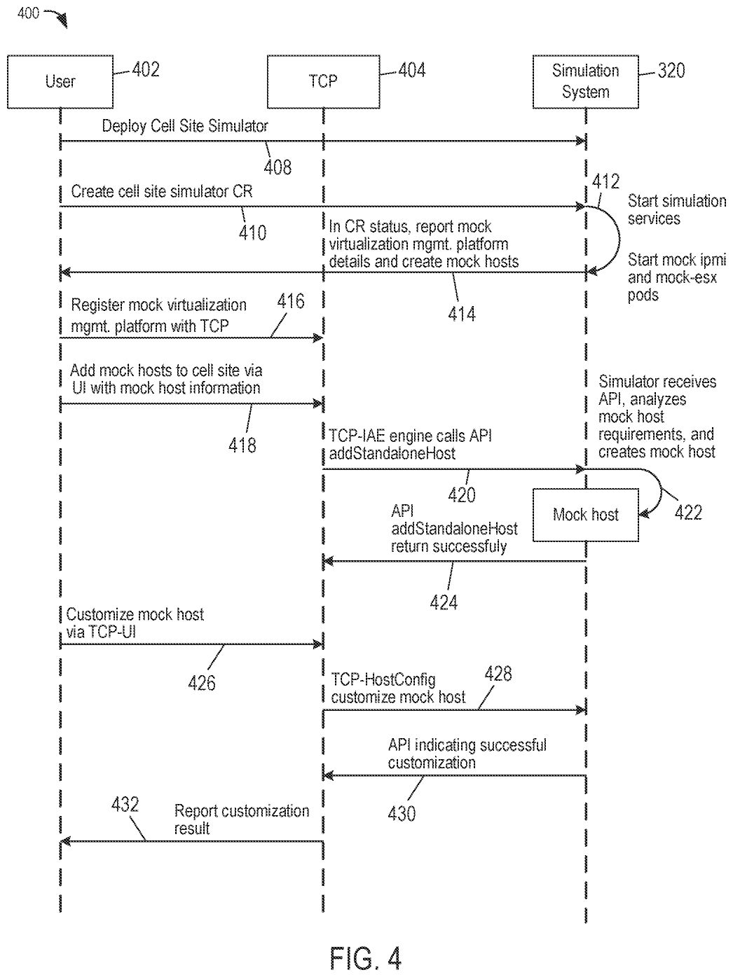

FIG. 4 shows an example call flow 400 for configuring mock hosts of cell sites and an LDC of a cellular network (e.g., mock hosts of cell sites 104 and an LDC in cellular network 100 described in FIG. 1). Call flow 400 includes operations that are performed in response to instructions received by a user 402 via a user interface (UI), operations performed by components of a TCP 404, and operations performed by a simulation system, such as simulation system 320 described in FIG. 3.

Call flow 400 begins, at operation 408, by user 402 transmitting instructions to simulation system 320 (e.g., via a UI) to deploy a cell site simulator, such as simulator 322 in FIG. 3, that simulates the functionality of a virtualization management platform for mock hosts. Simulator 322 is deployed in a pod in simulation system 320.

At operation 410, user 402 transmits instructions to simulation system 320 (e.g., via the UI) to create a cell site simulator CR for declaring desired states of the mock virtualization management platform (also referred to as the “mock VMP”) and the mock hosts. The cell site simulator CR is the input that describes the requirements for the mock virtualization management platform and the mock hosts.

At operation 412, simulation system 320 starts running simulator 322 to create the mock virtualization management platform and begin running mock IPMI and mock host pods in simulation system 320, described in detail below with reference to FIGS. 5A and 5B. In other words, simulation system 320 provisions mock virtualization management platform pods for the mock virtualization management platform, and provisions mock IPMI pods and mock host pods for the mock hosts. Simulation system 320 returns a report of the mock virtualization management platform and creates login information for each of the mock hosts to user 402, at operation 414. When the CR status stage indicates “provisioned,” simulator 322 is running, mock pods for IPMI server and SSH server are running, and hostname, username, and password are generated for each of the mock hosts of the cellular network. However, the mock hosts of the cell sites and the LDC are not, at this point, registered with the mock virtualization management platform.

At operation 416, the user registers the mock virtualization management platform with a control plane of TCP 404, such as TCP control plane 310 illustrated in FIG. 3. Further, at operation 418, the user uses a UI of the mock virtualization management platform to add mock hosts using host information. The host information may include hostnames, usernames, and passwords of the mock hosts.

In response to TCP control plane 310 receiving the registration of the mock virtualization management platform and mock host information, at operation 420, a TCP IAE, such as IAE 316 illustrated in FIG. 3, calls an API “addStandaloneHost” to send mock host requirements to simulator 322 of simulation system 320. The “addStandaloneHost” API creates a mock host using simulator 322, as illustrated at operation 422. Simulator 322 receives mock host requirements from the addStandaloneHost API and creates the mock host compatible with such requirements.

After the mock host has been created, at operation 424, simulator 322 notifies TCP 404 that the mock host has been successfully created and added to the mock virtualization management platform for management. The mock host may represent a host deployed at a cell site.

At operation 426, user 402 provides instructions to TCP 404 for customizing (i.e., configuring) the mock host (e.g., via the UI). For example, the mock host may be customized to enable a single root I/O virtualization (SR-IOV) for a BIOS (e.g., which enables the BIOS to allocate more peripheral component interconnect (PCI) resources to PCI express (PCIe) devices), firmware, and PCI devices (e.g., any device that can connect into the motherboard by utilizing the PCI slot). At operation 428, the TCP-HostConfig, such as HostConfig 312 in FIG. 3, transmits instructions to simulation system 320 to customize (i.e., configure) the cell site that contains the mock host in accordance with the user instructions.

At operation 430, simulation system 320 uses an API to report to TCP 404 that the mock host has been successfully configured in accordance with the user requested customization. At operation 432, TCP 404 informs user 402 that the mock host has been successfully customized (i.e., configured) (e.g., displays in the TCP UI that the cell site has been successfully configured).

FIGS. 5A and 5B show an exploded view of the simulation system 320 for creating mock hosts of RAN cell sites and a mobile core of an LDC. In FIGS. 5A and 5B, the simulation system 320 includes simulator 322, mock IPMI pods, mock host pods, and an ingress controller 502.

In FIG. 5A, ingress controller 502 has three input ports 504-506 (e.g., endpoints) for receiving information. Port 504 receives information from a virtualization platform (VP) API, as indicated by directional arrows 508 and 509. Port 505 receives information from an IPMI API as indicated by directional arrow 510. Port 506 receives information from an SSH server.

IAE 316 uses the VP API to send hostname, username, and password information for the mock hosts to ingress controller 502 of simulations system 320. HostConfig 312 uses the VP API, the IPMI API, and the SSH server or a host command over SSH, to send mock host configuration information to ingress controller 502 of simulation system 320.

IAE 316 and HostConfig 312 communicate with the mock virtualization management platform on port 504 using a fully qualified domain name (FQDN) mock-vmp.telco.io.443. HostConfig 312 connects to host OS with SSH service on port 506 using FQDN mock-host-n.telco.io:22, where n identifies the host. Further, HostConfig 312 connects with each of the IPMI pods, shown in FIG. 5B, on port 505 using FQDN mock-ipmi-n.telco.io:443. Ingress controller 502 manages and directs the flow of the information received from the VP APIs, IPMI API, and SSH server within simulation system 320.

In FIG. 5B, simulator 322 is implemented in a pod of the RDC 142. Simulator 322 generates a new mock host with 5G associated devices and registers the mock host with the mock virtualization management platform without any changes to IAE 316 or HostConfig 312. Simulator 322 uses a host template to generate mocks hosts. Details about the mock hosts are obtained from the host template which is loaded into simulator 322. Simulator 322 creates a mock virtualization management platform with FQDN mock.vmp.telco.io 516 and creates N mock hosts (e.g., where N is any positive integer) with FQDNs 518-520 (e.g., representing hosts of cell sites 104 in the cellular network) based on the host template with FQDN template.telco.io 522. Simulator 322 also creates mock hosts for the LDC.

For each mock host created by the simulator 322, simulator 322 also creates a corresponding mock IPMI pod and a mock host pod for each mock host. For example, simulator 322 creates an IPMI pod 526 with hostname mock-ipmi-1 and a host pod 528 with hostname mock-host-1 for a first mock host (e.g., mock host 1). A mock IPMI pod is an IPMI interface simulator that responds to IPMI requests from HostConfig 312. A mock host pod is an interface simulator that mocks SSH server and ESX OS commands received from HostConfig 312. In this example, the IMPI API used by HostConfig 312 to communicate with IPMI pod 526 is FQDN mock-ipmi-1.telco.io:443. The SSH server used by the HostConfig 312 to communicate with host pod 528 is FQDN mock-host-1.telco.io:22.

Additional details regarding the cell site simulator CR are provided in patent application Ser. No. 17/887,761, filed Aug. 15, 2022, and entitled “Automated Methods and Systems for Simulating a Radio Access Network,” the entire contents of which are incorporated by reference herein.

FIG. 6 illustrates an example self-adaptive, cell site simulation system, such as simulation system 320 introduced in FIG. 3. As described above, simulation system 320 includes a simulator 322 and a simulation operator 324, where the simulation operator 324 includes an upgrade controller 332 and an upgrade analyzer 334. Simulator 322 and simulation operator 324 of simulation system 320 are configured to (1) dynamically discover the upgrade of a Kubernetes management cluster 326, (2) detect a new Kubernetes version release supported by Kubernetes management cluster 326, and (3) self-upgrade in simulation system 320 to make a mock VM template. The mock VM template is used by simulator 322 for simulating mock VMs, and specifies the latest Kubernetes version release supported by Kubernetes management cluster 326. Simulation system 320 may subsequently use the new mock VM template to simulate mock VMs in the test infrastructure which are compatible with the latest Kubernetes version release, and thus able to take advantage of features offered by the updated software. FIG. 7 is an example call flow 700 for automatically deploying new mock VM templates in example simulation system 320 of FIG. 6. FIGS. 6 and 7 are described in conjunction below.

Prior to beginning operations in call flow 700 to deploy new mock VM templates in simulation system 320, as illustrated in FIG. 6, a user 602 (e.g., administrator) may have (1) transmitted instructions to simulation system 320 (e.g., via a UI) to deploy simulator 322 in simulation system 320, as well as (2) transmitted instructions to simulation system 320 (e.g., via the UI) to create a cell site simulator CR for declaring desired states of a mock virtualization management platform and mock hosts in simulation system 320, similar to operations 408 and 410 described in FIG. 4. User 602 may have communicated such instructions to simulation system via an API server 610. The cell site simulator CR, created based on the user-provided instructions, may be stored in cluster store (etcd) 612. Further, similar to operation 412 described in FIG. 4, in response to receiving the cell site simulator CR, simulation system 320 may have started running simulator 322 to create the mock virtualization management platform and begin running mock pods and mock hosts in simulation system 320. Simulator 322 may have also created mock VMs in simulation system 320 using a mock VM template which mocks a VM template that currently serves as a baseline image for creating and deploying VMs at RAN cell sites in a cellular network (e.g., a cellular network which the simulation system 320 is configured to simulate).

After simulating mock clusters, hosts, and VMs according to cell site simulator CR, a simulation operator 324 may be deployed in simulation system 320. As illustrated, simulation operator 324 includes upgrade controller 332 and upgrade analyzer 334. Upgrade controller 332 is configured to monitor for upgrades to Kubernetes management cluster 326. In certain embodiments, monitoring for upgrades to Kubernetes management cluster 326 includes monitoring for new resources at Kubernetes management cluster 326, including a new telecommunication cloud automation (TCA) bill of materials (BOM) release (TBR) resource on Kubernetes management cluster 326. A new TBR resource is generated at Kubernetes management cluster 326, by a TCA operator 604, when user 602 upgrades Kubernetes management cluster 326 to support new OSs or new Kubernetes version releases. The new TBR resource may specify, at least, which Kubernetes version(s) are supported and made available by Kubernetes management cluster 326, following the upgrade.

Accordingly, as illustrated in call flow 700, in response to user 602 transmitting instructions to TCP 404 to upgrade Kubernetes management cluster, and TCP 404 upgrading Kubernetes management cluster 326 (e.g., illustrated at operations 708 and 708, respectively), a new TBR is created at Kubernetes management cluster 326, at operation 710. For example, the new TBR may TBR 3 illustrated in FIG. 6.

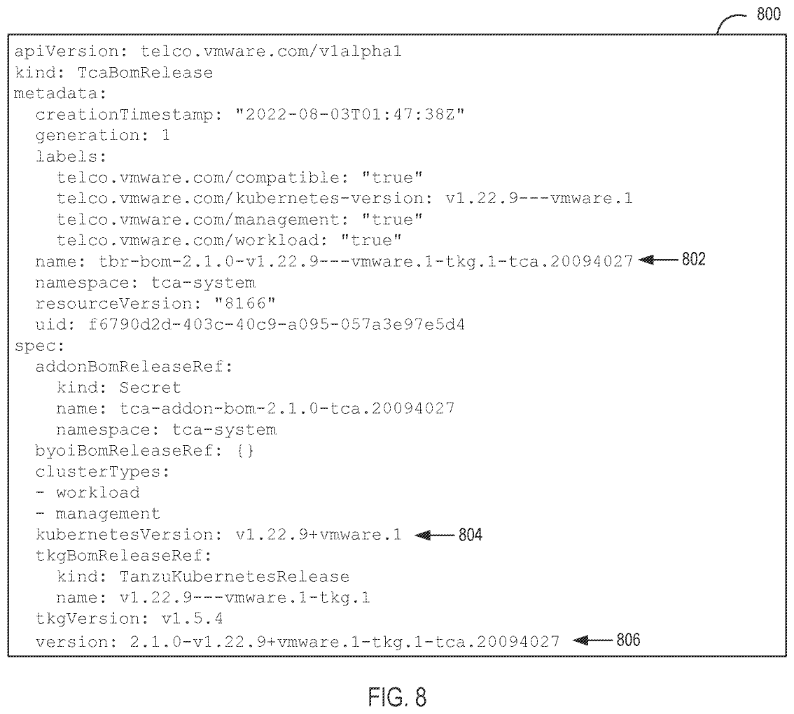

FIG. 8 illustrates an example TBR resource 800 generated at Kubernetes management cluster 326, according to an example embodiment of the present disclosure. As illustrated, example TBR resource 800 includes a name 802, a supported Kubernetes version 804, and a Kubernetes management cluster version 806 (e.g., “tkgVersion,” or Tanzu Kubernetes Grid (TKG) version). Supported Kubernetes version 804 is “v1.22.9+vmware.1.” Kubernetes management cluster version is “2.1.0.22.9+vmware.1-tkg.1-tca.20094027.” Name 802 shown in example TBR resource 800 includes information about the supported Kubernetes version 804 and the Kubernetes management cluster version 806. In particular, name 802 is “tbr-bom-2.1.0-v1.22.9---vmware.1-tkg.1-tca.20094027” which concatenates, at least, information about the supported Kubernetes version 804 and Kubernetes management cluster version 806.

Returning to FIG. 7, based on monitoring for new resources at Kubernetes management cluster 326, simulation operator 324 of simulation system 320 may discover the new TBR resource generated at Kubernetes management cluster 326. More specifically, as illustrated in FIG. 6, upgrade controller 332 of simulation operator 324 discovers the new TBR resource. As illustrated in FIG. 8, the TBR resource may specify a new Kubernetes version release supported by Kubernetes management cluster 326.

In response to discovering the new TBR resource, upgrade controller 332 of simulation operator 324 parses the new TBR resource to determine a new Kubernetes version supported by Kubernetes management cluster 326 that is specified in the new TBR resource. For example, upgrade controller 332 may use the name, as illustrated in example TBR resource 800 of FIG. 8, to determine the latest Kubernetes version supported by Kubernetes management cluster 326. As such, at operation 714 in FIG. 7, simulation operator 324 (e.g., upgrade controller 332 of simulation operator 324) triggers the creation of new mock VM template(s) in simulation system 320 which match the new TBR. More specifically, upgrade controller 332 of simulation operator 324 triggers the creation of new mock VM template(s), by simulator 322 in simulation system 320, which include one or more properties configured for the template, and further specify that the mock VM template(s) are compatible with the latest Kubernetes version indicated in the new TBR resource.

Accordingly, at operation 716 in FIG. 7, new mock VM template(s) are created by simulator 322. For example, in FIG. 6, simulator 322 creates a new mock VM template with a naming convention “template<OSNameVersion><KubernetesVersion><xxx>” set to “template-photon3-v2.21.1I+vmware.1-host-1.” After successful creation, upgrade controller 332 of simulation operator 324 may update a status of the cell site simulator CR to list the new mock VM template(s) created in simulation system 320.

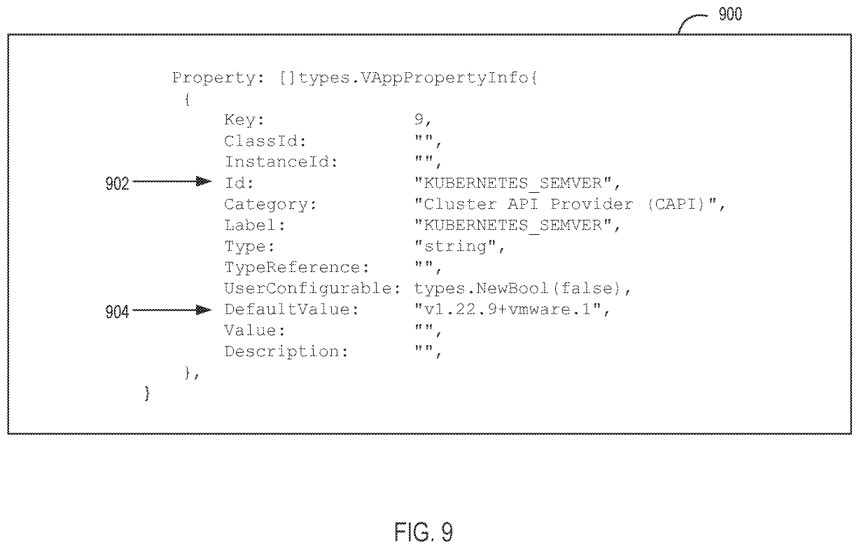

FIG. 9 illustrates example properties of a mock VM template 900 generated by simulator 322 in simulation system 320, according to an example embodiment of the present disclosure. As illustrated, example mock VM template 900 sets a VM property as “KUBERNETES_SEMVER” (at ID 902). ID “KUBERNETES_SEMVER” corresponds to Kubernetes version “v1.24.9+vmware.1” (at DefaultValue 904). ID “KUBERNETES_SEMVER” may be a label given to this Kubernetes version for referencing this Kubernetes version. It is noted that mock VM template 900 is only an example and is not representative of “template-photon3-v2.21.11+vmware.1-host-1” created in FIG. 6. In FIG. 6, a different mock VM template is created specifying the correct Kubernetes version identified in the mock VM template's name.

At operation 718 in FIG. 7, simulator 322 deletes mock VM template(s) with VM properties having non-compatible Kubernetes version information (e.g., mock VM template(s) which are not compatible with the latest Kubernetes version release supported by Kubernetes management cluster 326). In some cases, this deletion is performed in response to a request from simulation operator (e.g., upgrade controller 332 in FIG. 6) to discard mock VM template(s) which are not supported by Kubernetes management cluster 326. In some cases, deleting mock VM template(s) reduces the load on simulation system 320.

At operation 720 in FIG. 7, simulation operator 324 indicates to user 602 that the new mock VM template is ready for use. As such, at operation 722, user 602 triggers an upgrade using the new mock VM template in simulation system 320, and simulator 322 begins the requested upgrade. The upgrade is performed according to an upgrade strategy proposed for upgrading, at least, mock VMs in the simulated infrastructure with little to no effect on performance and/or downtime. The upgrade strategy may be provided by user 602. In certain embodiments, the upgrade strategy is an in-sequence VM upgrade strategy (e.g., a proposed strategy for removing one VM and creating a new VM in sequence, as opposed to removing and/or creating several VMs in a batch). Simulator 322 may record VM operations (e.g., VM clone and VM removal operations) during execution of the upgrade as VM operations records 620, illustrated in FIG. 6. For example, VM operations recorded for a batch upgrade (e.g., process of upgrading several components at a time) may include the following operations:

| Timestamp | VM/Machine/Node | Operation |
|---|---|---|
| Aug 19 00:32:21 | mc1-np1-669d947884-htp6r | removed |
| Aug 19 00:32:21 | mc1-np1-669d947884-pbjr9 | removed |
| Aug 19 00:32:21 | mc1-np1-669d947884-abdf8 | removed |
| Aug 19 00:32:56 | mc1-np1-669d947884-ccfas | created |
| Aug 19 00:32:59 | mc1-np1-669d947884-qwo1f | created |
| Aug 19 00:33:11 | mc1-np1-669d947884-pqfw9 | created |

As another example, VM operations recorded for an in-sequence upgrade may include the following operations:

| Timestamp | VM/Machine/Node | Operation |
|---|---|---|
| Aug 19 00:35:22 | mc1-np2-6f964b745b-tk559 | removed |
| Aug 19 00:35:49 | mc1-np2-6f964b745b-wmpv2 | created |
| Aug 19 00:36:15 | mc1-np2-6f964b745b-8v8gc | removed |
| Aug 19 00:36:20 | mc1-np2-6f964b745b-asg4s | created |
| Aug 19 00:36:41 | mc1-np2-6f964b745b-jgtdw | removed |
| Aug 19 00:36:51 | mc1-np2-6f964b745b-fdgfg | created |

At operation 726, an upgrade analyzer 334 of simulation operator 324 analyzes the upgrade strategy using VM operations records 620, and generates an upgrade strategy analysis report for user 602. At operation 728, the upgrade strategy analysis report is provided to user 602. User 602 may use the provided upgrade strategy analysis report to verify whether the upgrade actions performed are sufficient and/or verify the upgrade performance of the large scale, RAN deployment.

The ability of simulation system 320 to dynamically discover new TBRs generated on Kubernetes management cluster 326 and, in response, generate new VM template(s) on simulation system 320 to prepare simulation system 320 for upgrade, enables user 602 to perform continuous upgrading without needing to perform any configuration operations on simulation system 320.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)-CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for preparing a simulation system to simulate upgrade operations for a distributed container orchestration system, comprising:
monitoring, by a simulation operator of the simulation system, for new resources generated at a management cluster in the distributed container orchestration system;
based on the monitoring, discovering, by the simulation operator, a new resource generated at the management cluster specifying a version of container orchestration software supported and made available by the management cluster; and
triggering, by the simulation operator, a creation of a new mock virtual machine (VM) template in the simulation system specifying the version of the container orchestration software, wherein the simulation system is configured to use the new mock VM template for simulating mock VMs in the simulation system that are compatible with the version of the container orchestration software supported and made available by the management cluster.

2. The method of claim 1, further comprising:
in response to the triggering, creating, by a simulator in the simulation system, the new mock VM template specifying the version of the container orchestration software; and
discarding, by the simulator, any mock VM templates in the simulation system specifying a different version of the container orchestration software than the version of the container orchestration software supported and made available by the management cluster.

3. The method of claim 2, further comprising:
simulating, by the simulator, the upgrade operations for the distributed container orchestration system using the new mock VM template, wherein simulating the upgrade operations comprises, at least, simulating the mock VMs in the simulation system using the new mock VM template;
recording, by the simulator, each of the upgrade operations performed;
analyzing, by an upgrade analyzer in the simulation system, the upgrade operations recorded to generate an upgrade strategy analysis report; and
providing, by the upgrade analyzer to a user, the upgrade strategy analysis report.

4. The method of claim 3, wherein:
the distributed container orchestration system is distributed across a cellular network comprising multiple cell sites; and
the mock VMs simulated in the simulation system are simulated to represent VMs deployed at the multiple cell sites.

5. The method of claim 1, wherein the new resource generated at the management cluster specifying the version of the container orchestration software supported and made available by the management cluster comprises a telecommunications cloud automation (TCA) bill of materials (BOM) release (TBR) resource.

6. The method of claim 1, wherein the version of container orchestration software is specified in, at least, a name of the new resource generated at the management cluster.

7. The method of claim 1, wherein the new resource is generated at the management cluster based on an upgrade applied to the management cluster.

8. A system comprising:
one or more processors; and
at least one memory, the one or more processors and the at least one memory configured to:
monitor, by a simulation operator of a simulation system, for new resources generated at a management cluster in a distributed container orchestration system;
based on the monitoring, discover, by the simulation operator, a new resource generated at the management cluster specifying a version of container orchestration software supported and made available by the management cluster; and
trigger, by the simulation operator, a creation of a new mock virtual machine (VM) template in the simulation system specifying the version of the container orchestration software, wherein the simulation system is configured to use the new mock VM template for simulating mock VMs in the simulation system that are compatible with the version of the container orchestration software supported and made available by the management cluster.

9. The system of claim 8, wherein the one or more processors and the at least one memory are further configured to:
in response to the triggering, create, by a simulator in the simulation system, the new mock VM template specifying the version of the container orchestration software; and
discard, by the simulator, any mock VM templates in the simulation system specifying a different version of the container orchestration software than the version of the container orchestration software supported and made available by the management cluster.

10. The system of claim 9, wherein the one or more processors and the at least one memory are further configured to:
simulate, by the simulator, upgrade operations for the distributed container orchestration system using the new mock VM template, wherein simulating the upgrade operations comprises, at least, simulating the mock VMs in the simulation system using the new mock VM template;
record, by the simulator, each of the upgrade operations performed;
analyze, by an upgrade analyzer in the simulation system, the upgrade operations recorded to generate an upgrade strategy analysis report; and
provide, by the upgrade analyzer to a user, the upgrade strategy analysis report.

11. The system of claim 10, wherein:
the distributed container orchestration system is distributed across a cellular network comprising multiple cell sites; and
the mock VMs simulated in the simulation system are simulated to represent VMs deployed at the multiple cell sites.

12. The system of claim 8, wherein the new resource generated at the management cluster specifying the version of the container orchestration software supported and made available by the management cluster comprises a telecommunications cloud automation (TCA) bill of materials (BOM) release (TBR) resource.

13. The system of claim 8, wherein the version of container orchestration software is specified in, at least, a name of the new resource generated at the management cluster.

14. The system of claim 8, wherein the new resource is generated at the management cluster based on an upgrade applied to the management cluster.

15. A non-transitory computer-readable medium comprising instructions that, when executed by one or more processors of a computing system, cause the computing system to perform operations for preparing a simulation system to simulate upgrade operations for a distributed container orchestration system, the operations comprising:
monitoring, by a simulation operator of the simulation system, for new resources generated at a management cluster in the distributed container orchestration system;
based on the monitoring, discovering, by the simulation operator, a new resource generated at the management cluster specifying a version of container orchestration software supported and made available by the management cluster; and
triggering, by the simulation operator, a creation of a new mock virtual machine (VM) template in the simulation system specifying the version of the container orchestration software, wherein the simulation system is configured to use the new mock VM template for simulating mock VMs in the simulation system that are compatible with the version of the container orchestration software supported and made available by the management cluster.

16. The non-transitory computer-readable medium of claim 15, wherein the operations further comprise:
in response to the triggering, creating, by a simulator in the simulation system, the new mock VM template specifying the version of the container orchestration software; and
discarding, by the simulator, any mock VM templates in the simulation system specifying a different version of the container orchestration software than the version of the container orchestration software supported and made available by the management cluster.

17. The non-transitory computer-readable medium of claim 16, wherein the operations further comprise:
simulating, by the simulator, the upgrade operations for the distributed container orchestration system using the new mock VM template, wherein simulating the upgrade operations comprises, at least, simulating the mock VMs in the simulation system using the new mock VM template;
recording, by the simulator, each of the upgrade operations performed;
analyzing, by an upgrade analyzer in the simulation system, the upgrade operations recorded to generate an upgrade strategy analysis report; and
providing, by the upgrade analyzer to a user, the upgrade strategy analysis report.

18. The non-transitory computer-readable medium of claim 17, wherein:
the distributed container orchestration system is distributed across a cellular network comprising multiple cell sites; and
the mock VMs simulated in the simulation system are simulated to represent VMs deployed at the multiple cell sites.

19. The non-transitory computer-readable medium of claim 15, wherein the new resource generated at the management cluster specifying the version of the container orchestration software supported and made available by the management cluster comprises a telecommunications cloud automation (TCA) bill of materials (BOM) release (TBR) resource.

20. The non-transitory computer-readable medium of claim 15, wherein the version of container orchestration software is specified in, at least, a name of the new resource generated at the management cluster.
